(19) United States
(12) Patent Application Publication
(10) Pub. No.: US 2006/0132584 A1
(43) Pub. Date: Jun. 22, 2006

(54) System and Method for Feeding and Cutting Media for Continuous Printing

(76) Inventors: Brian C. Jobmann, Alpharetta, GA (US); Peter Michael Mueller, Suwanee, GA (US)

Correspondence Address: JOHN S. PRATT, ESQ;KILPATRICK STOCKTON, LLP, 1100 PEACHTREE STREET, ATLANTA, GA, 30309, US

(21) Appl. No.: 11/275,227

(22) Filed: Dec. 20, 2005

Related U.S. Application Data
(60) Provisional application No. 60/637,493, filed on Dec. 20, 2004.

(51) Int. Cl. B41J 2/325

(52) U.S. Cl. 347/219

(57) ABSTRACT

The present invention provides a feeder cutter that pulls media from a continuous roll of media and feeds it to a print engine. The feeder cutter includes a number of subsystems that draw media from the media source, present the media to the print engine and maintain tension on the media. The feeder cutter isolates the velocity used to feed media from the media source from the velocity used to feed media within the print engine. At the end of a print job, the feeder cutter cuts the media under tension and minimizes the media wasted between print jobs.

### CROSS-REFERENCE TO RELATED APPLICATION

This application claims priority to U.S. Application No. 60/637,493 entitled “Feeding Cutting System” filed Dec. 20, 2004, which is incorporated herein by reference.

### BACKGROUND OF THE INVENTION

1. Field of the Invention

The invention generally relates to the automatic feeding and cutting of media within a print system, and in particular to isolating the media feed velocity used to draw media from a media source from the media feed velocity within a print engine.

2. Description of the Related Art

Conventional print engines produce printed media by feeding precut media from a supply location within the print engine, through a transfer area within the print engine where ink or toner of the appropriate colors is deposited in a controlled geometric relationship to produce a combined color or monochrome image on the media, through an ink drying area or toner fusing section of the print engine and into a completed print storage area. The image size which can be produced is limited to the physical path boundaries of the media path through the print engine. The size of the acceptable print media is commonly referred to as the page size or sheet size. Although several images can be printed on the same page or sheet, the page or sheet size in current print engines is finite and typically limited to industry standards for the print media.

In a conventional print engine, the media must be of a certain width, length, and thickness. The media must match the size of the job to be printed, and is usually no more than 24″-48″ in length and 11 inches in width per page or sheet. While this simplifies the mechanical handling of the media for the print engine, it limits what page or sheet sizes can be printed. Media is usually presented in precut sheets of the appropriate size to match the capabilities of the particular print engine.

FIG. 1 illustrates a typical print engine. The print engine 10 includes a frame or housing structure 15 and a media feed roller 20 with an attached feed motor 25 that drives the media 30 through friction contact from the media tray 35 through the media input path guide 40 and into contact with the pair of input rollers 45. The media feed roller, the feed motor and media tray generally constitute the standard media feeding mechanism. Since the media is precut, no cutting is required. The media generally follows a planar path with different manufacturers varying the relative geometry and positions of the media feed components to suit their preferred configurations. Typically, the configuration of the input rollers, the feed motor, the gear train and the input rollers matches the media feed velocity at the media feeding mechanism to the media feed velocity at the input rollers.

Adjacent and following the input rollers is the print area 60 which can have many variations. The print area is where the ink or toner 65 stored in one or more print heads 70 is transferred to the media by contact or other means. The print engine control system 75 coordinates the transfer of the ink or toner to the media at a relative position along the path of the moving media. To maintain registration quality, a pair of exit rollers 80 is used to match the media feed velocity at the exit rollers with the media feed velocity at the input roller. Following the print area is the ink drying/toner fusing area 85 and the exit area 90 for the completed media. These areas allow for final conditioning of the ink or toner on the media.

A typical sheet feed printer can only handle media of a certain size. To allow for longer page or sheet usage, some manufacturers have adapted a sheet feed printer to accept a roll of media. FIG. 2 illustrates this concept. The print engine apparatus 10 is similar to that described in connection with FIG. 1. However, the input rollers pull media from a continuous roll 100 of media, instead of feeding individual pages or sheets. A cutter 90 is placed between the media roll and the input roller. The cutter is powered by a motor 95 and cuts the media in response to a command from the print engine control system 75. Some cutters cut the media while it is stopped, while other cutters cut the media as it is moving.

Maintaining a uniform velocity throughout the print area is a key to registration quality. Relative velocity changes due to starting/stopping, media separation from the media roll, torque variation in the feeder cutter motors, and other friction causes can create tension changes, which can affect media velocity and registration. In systems with a separate drive system for the feed roller, this problem is further complicated by having to control velocities at the feed roller and the input roller.

### BRIEF SUMMARY OF THE INVENTION

The present invention provides a cutter feeder that provides the proper tensioning of media being supplied to a print engine. The present invention generally comprises a unique set of subsystems positioned through a common alignment frame to control media feed and tension into the print engine. The subsystems include a media feed subsystem, a tension control subsystem, a home feed subsystem, a top of form subsystem, an on-the-fly cutting subsystem and a media guidance subsystem.

The alignment frame attaches to the print engine and forms the framework of the feeder cutter. The alignment frame forms a geometric reference frame for mounting the other subsystems relative to the media and the print engine so that the alignment of the subsystems is maintained during operation.

The media feed subsystem pulls media from a bulk media roll supported on a separate media stand. The media feed subsystem is comprised of a traction feed roller set powered through a mechanical reduction from a motor. The media feed subsystem can handle a wide variety of torques associated with different roll diameters and inertias. A sensor monitors the speed of the media entering the print engine and controls the rotational velocity of the media feed subsystem. The velocity control is a closed loop circuit that matches the velocity of the media feed roller to the velocity associated with the print engine. Power to the sensor and motor can be supplied from the print engine or from an independent power source.

The tension control subsystem maintains a constant tension in the media to the print engine regardless of the torque variations associated with the media feed subsystem or variations in the print engine operating velocity. The tension control subsystem uses a weighted mass loading a roller operating as an accumulator configuration in the media path. The roller is allowed to move in a vertical plane perpendicular to the media path. The media is guided from a horizontal plane orientation into a vertical plane and returned to the horizontal plane, allowing the weighted roller to transmit loaded catenary tension to the media. An optical sensor determines the position of the tension control subsystem, which is used to control the velocity of the media feed subsystem.

The home feed subsystem pushes the media into the print engine and positions the media so that at the initiation of the print cycle the print engine input feed rollers can pull in the media. The home feed subsystem is comprised of a traction feed roller set powered through a mechanical reduction from a motor. The mechanical reduction is coupled in series to the roller through a one-way roller clutch. Energizing the motor transmits torque to the roller for feed motion. Motor power can be supplied from the print engine or from an independent power source. A motor energizing signal is supplied from the print engine or system controller. After the print cycle is initiated, the print engine begins to pull the media at a velocity higher than the home feed subsystem set point. The one-way roller clutch is overcome and the roller is free-wheeling at which point the home feed motor is de-energized. Also connected in series between the home feed roller and frame is another one-way clutch which prevents the roller and hence the media from reversing direction. This directional constraint prevents the media from slipping backwards along the media path due to the operation of the tension control subsystem after the media has been cut.

The top of form subsystem uses a combination emitter and opposing receiver sensor components on either one side or both sides of the media in conjunction with a reference mark or edge point on the media to determine the top edge of the print area. Information from the sensor components is transmitted to the print engine where it is used in conjunction with other internal print engine parameters to determine image registration relative to the signal position index. Sensor power can be supplied from the print engine apparatus or from an independent power source.

The on-the-fly cutting subsystem cuts the media completely across the media width at a programmed position along the media length. The cut point is controlled by the print engine and the cut is initiated by energizing a rotary solenoid mechanically connected to a rotating cutter blade, which is positioned below the media path and opposed by a stationary cutter blade having an identical edge location geometry above the media path. Initiation of the cut signal causes the rotary blade to shear through the media width starting from one edge and progressing to the opposite edge of the media. Rotary solenoid power can be supplied from the print engine or from an independent power source. Since the media has a constant velocity in the on-the-fly cutting subsystem and the cut is not made instantaneously, the cut edge exhibits a non-perpendicular, or angular, cut edge relative to either edge of the media. The degree of angularity, including true perpendicularity, can be modified by changing the velocity of the media, the speed of the solenoid actuation of the rotary cutter, the shape of the rotary and stationary blade edge, and/or the positioning geometry of the rotary and stationary blade in the alignment frame subsystem relative to the media path. Alternatively, the on-the-fly cutting subsystem can cut the media when the media is stopped.

The media guidance subsystem positions the media during operation, so that the media path is aligned to the media path within the print engine, thus preventing registration skewing, lifting, or other deviation from that required for proper registration of the image to the media. The media guidance subsystem includes mechanical linkages containing positioning faces to guide the edge of the moving media. The guides have variable media width positioning capability, as well as a common user interface to manually move all of the guides into the desired width position at the same time while moving equidistant in unison from the media path centerline. The guides are of multi-component construction to allow for user substitution of the guiding face to match a particular media type.

A primary object of the present invention is to provide a feeder cutter that overcomes the shortcomings of the prior art devices. These and other aspects, features and advantages of the present invention may be more clearly understood and appreciated from a review of the following detailed description of the disclosed embodiments and by reference to the appended drawings and claims.

### BRIEF DESCRIPTION OF THE SEVERAL VIEWS OF THE DRAWING

Various other objects, features and attendant advantages of the present invention will become fully appreciated as the same becomes better understood when considered in conjunction with the accompanying drawings, in which like reference features designate the same or similar parts throughout the several views, and wherein:

FIG. 1 illustrates a typical prior art print system that utilizes cut page or sheet media.

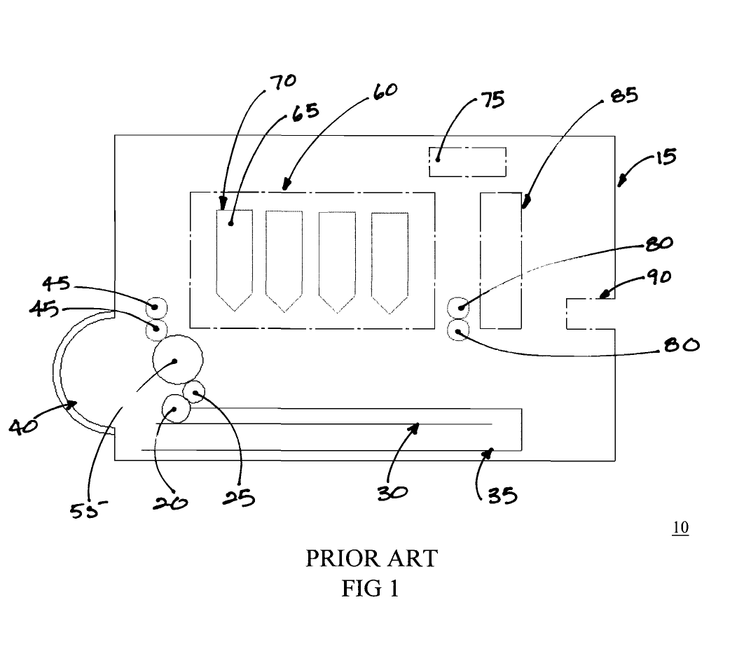

FIG. 2 illustrates a typical prior art print system that utilizes continuous media.

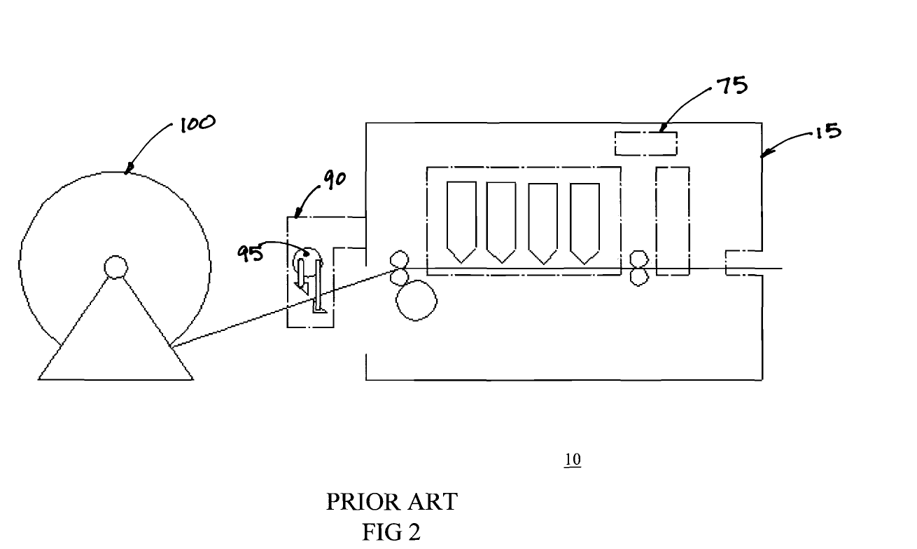

FIG. 3 illustrates a feeder cutter in accordance with an embodiment of the present invention.

FIG. 4 further illustrates the exemplary feeder cutter.

FIG. 5 illustrates an exemplary alignment frame in accordance with an embodiment of the present invention.

FIG. 6 further illustrates the exemplary alignment frame.

FIG. 7 illustrates a media feed subsystem in accordance with an embodiment of the present invention.

FIG. 8 further illustrates the exemplary media feed subsystem.

FIG. 9 illustrates a tension control subsystem in accordance with an embodiment of the present invention.

FIG. 10 further illustrates the exemplary tension control subsystem.

FIG. 11 illustrates a home feed subsystem in accordance with an embodiment of the present invention.

FIG. 12 further illustrates the exemplary home feed subsystem.

FIG. 13 illustrates an on-the-fly cutting subsystem in accordance with an embodiment of the present invention.

FIG. 14 further illustrates the exemplary on-the-fly cutting subsystem.

FIG. 15 illustrates a top of form subsystem in accordance with an embodiment of the present invention.

FIG. 16 further illustrates the exemplary top of form subsystem.

FIG. 17 illustrates a media guidance subsystem in accordance with an embodiment of the present invention.

FIG. 18 further illustrates the exemplary media guidance subsystem.

FIG. 19 further illustrates the exemplary media guidance subsystem.

### DETAILED DESCRIPTION OF THE INVENTION

The present invention is directed to automatically feeding and cutting media within a print system so that the tension used to feed media from a media source is independent of the tension used to feed the media into the print engine. Briefly described the invention provides a media feed subsystem that feeds the media from the media source, a tension control subsystem that controls the tension of the media and a home feed subsystem that initially feeds the media into the print engine and works with the tension control subsystem to maintain tension on the media. In one embodiment, the feeder cutter of the present invention is designed for use with an existing print engine, such as a table top sheet feed printer.

Exemplary Feeder Cutter

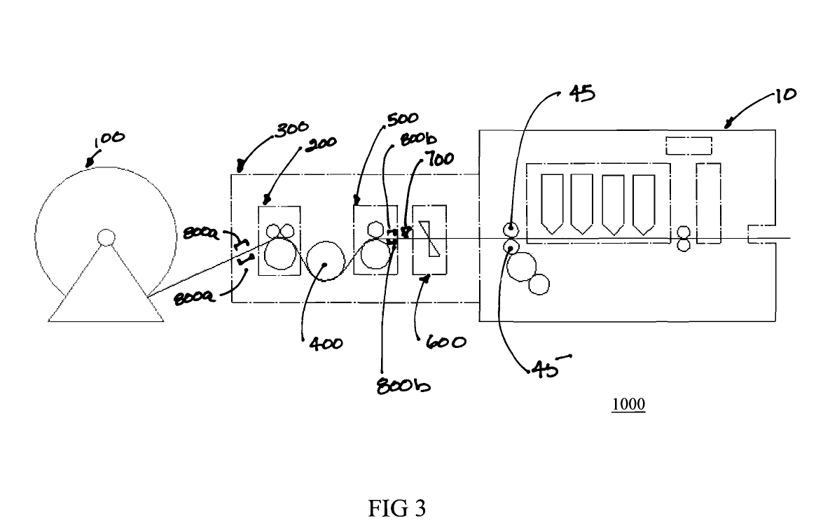

FIG. 3 illustrates one embodiment of the feeder cutter that pulls media from a continuous roll of media 100 or other media source and feeds it to the print engine 10. The feeder cutter includes a media feed subsystem 200, a tension control subsystem 400, a home feed subsystem 500, a top of form subsystem 700, an on-the-fly cutting subsystem 600 and a media guide subsystem 800a, 800b. An alignment frame 300 positions the subsystems relative to each other, as well as relative to the media source and the print engine.

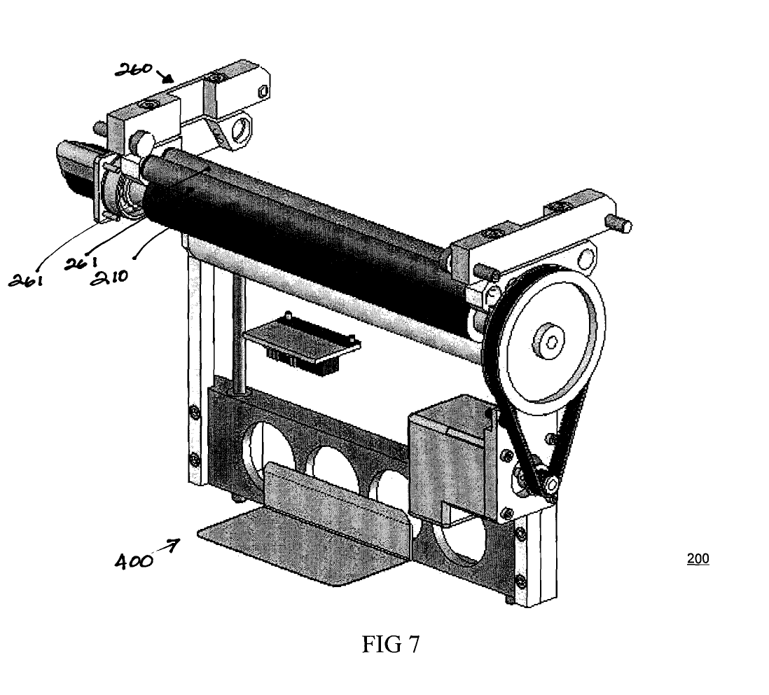

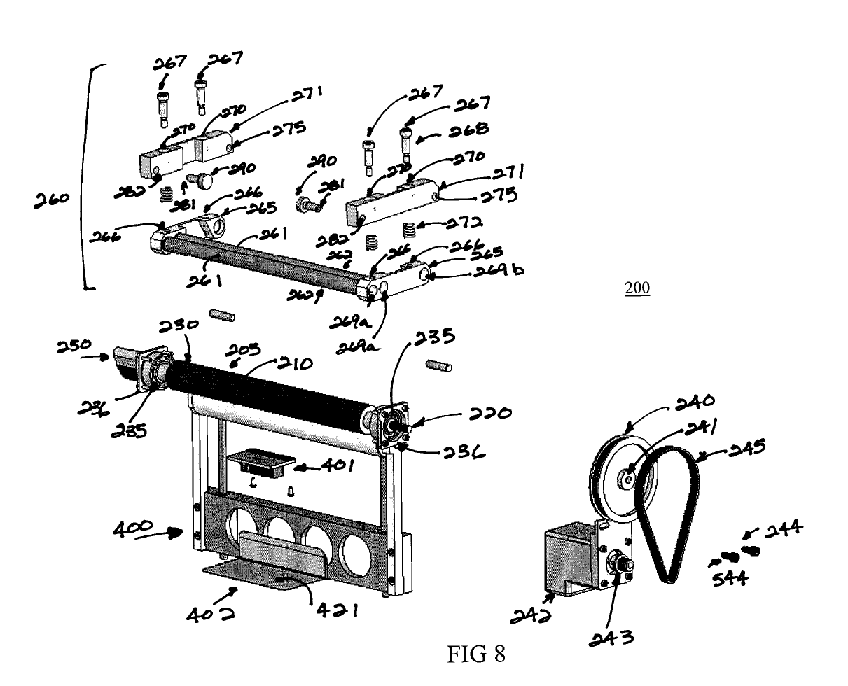

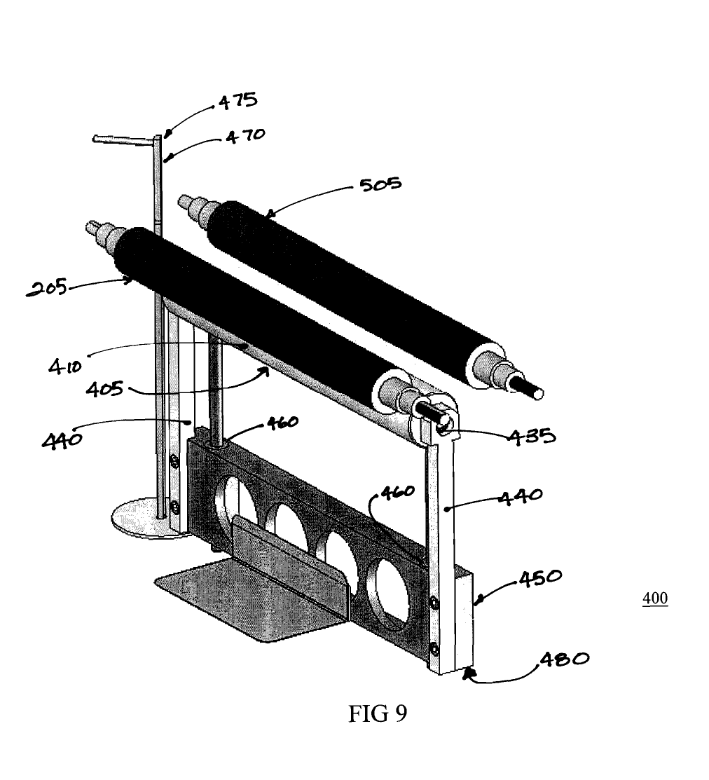

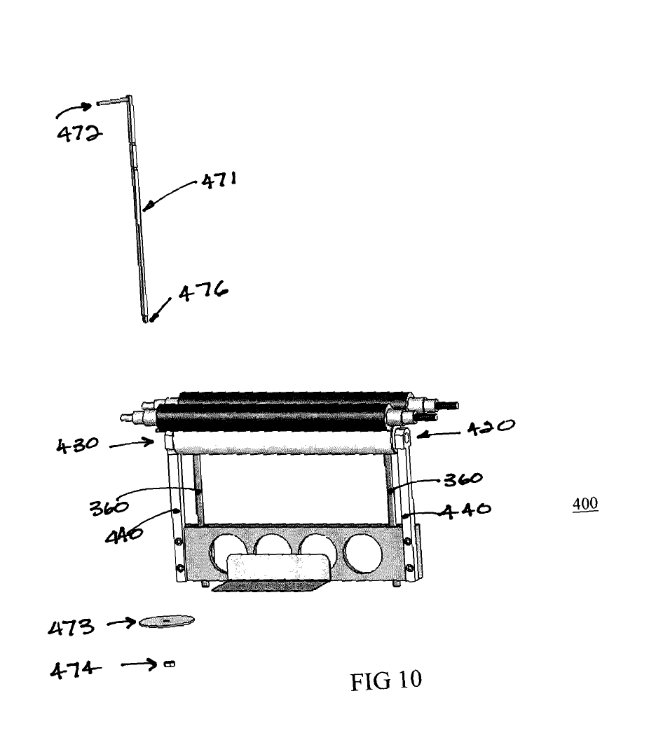

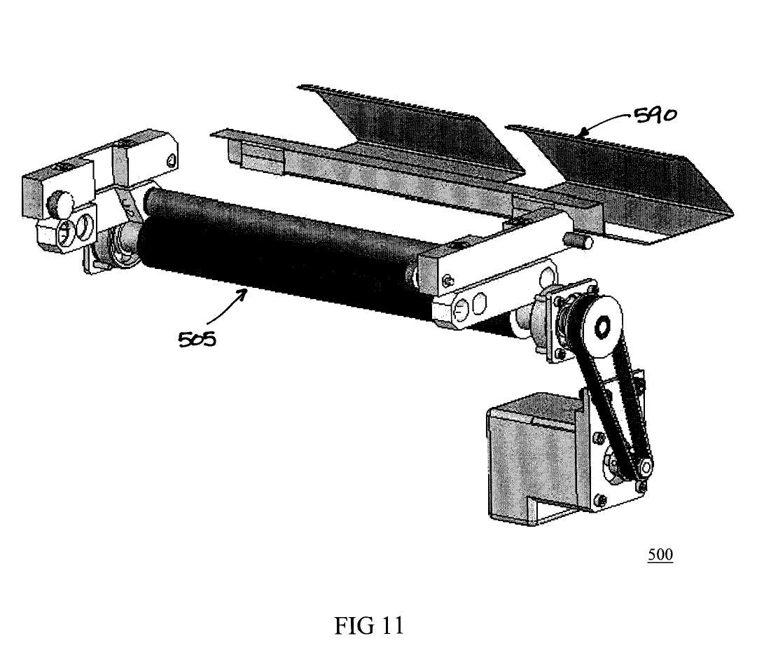

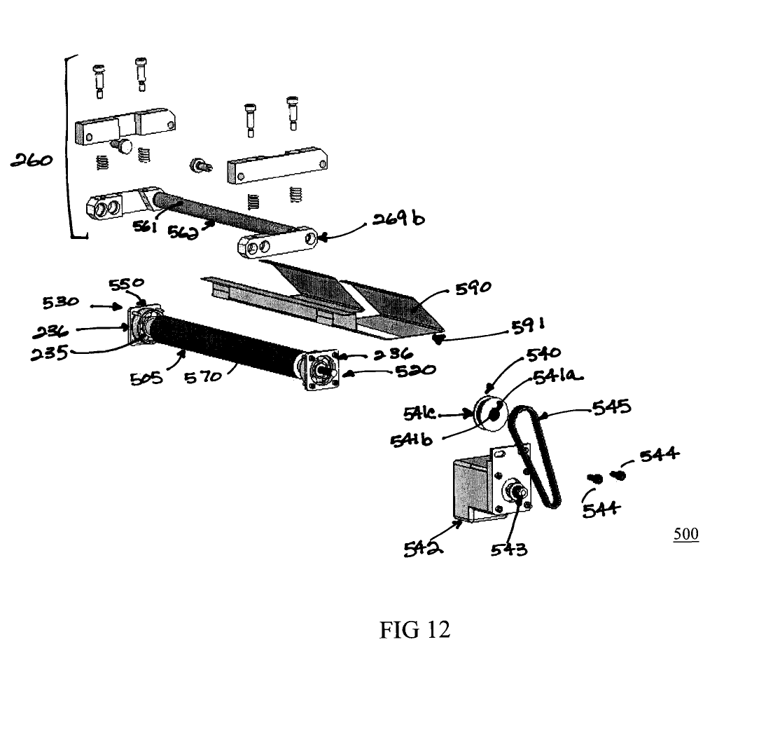

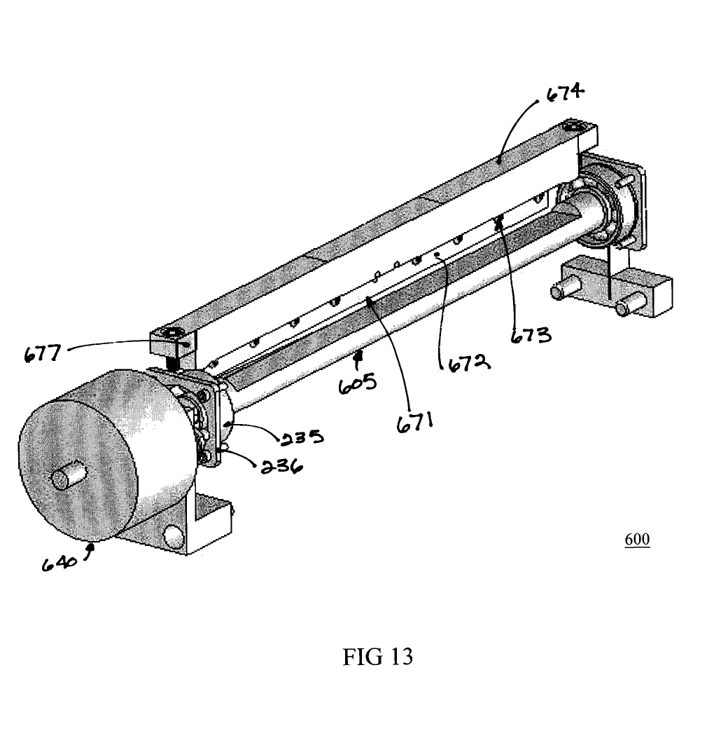

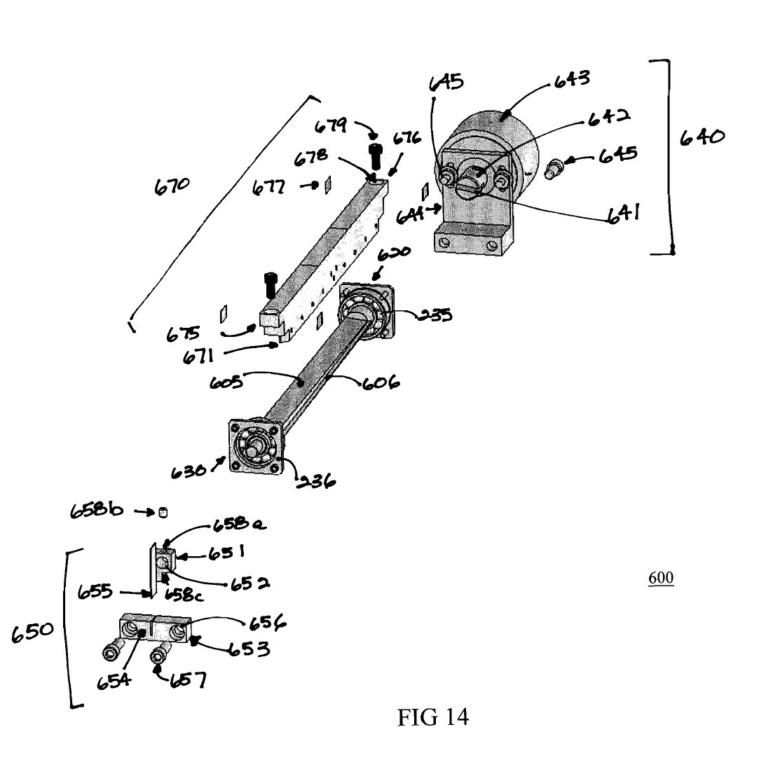

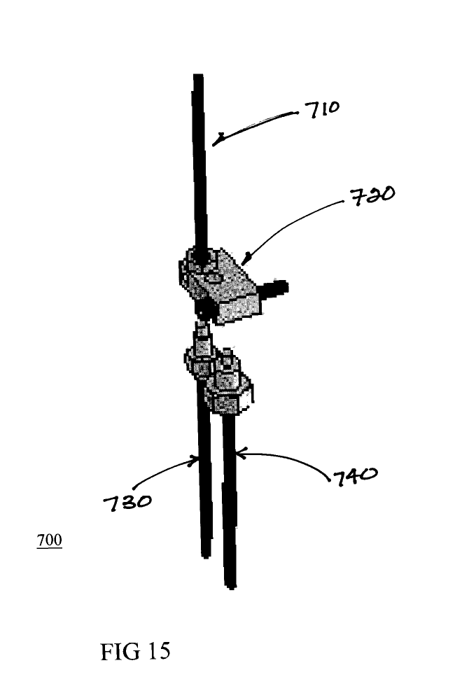

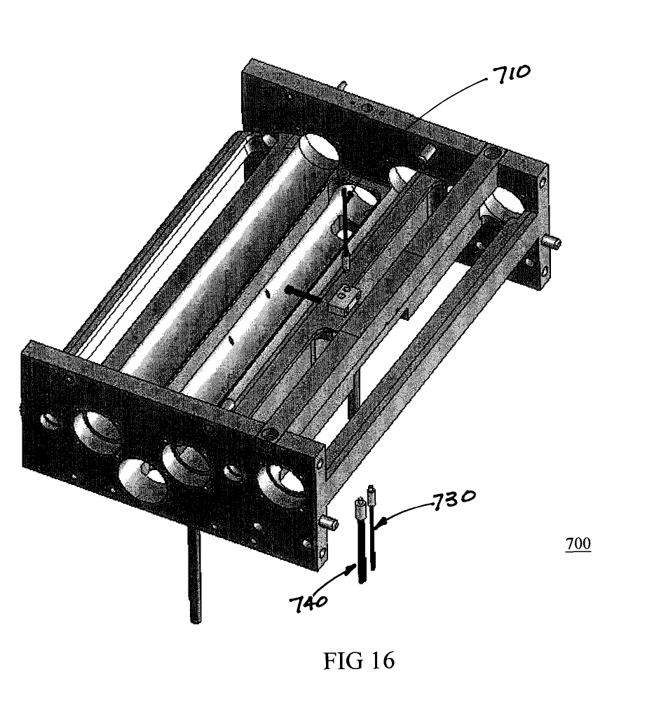

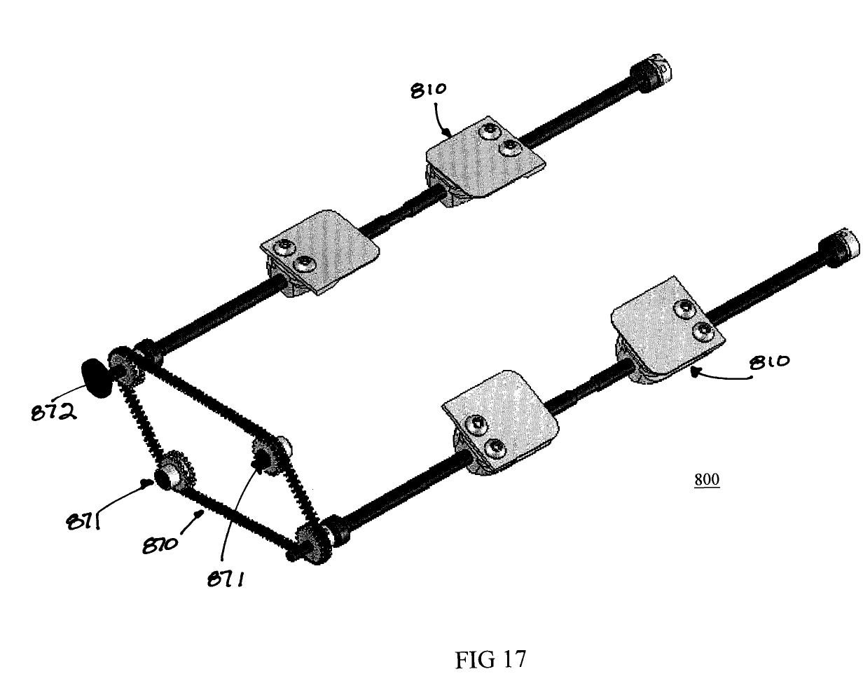

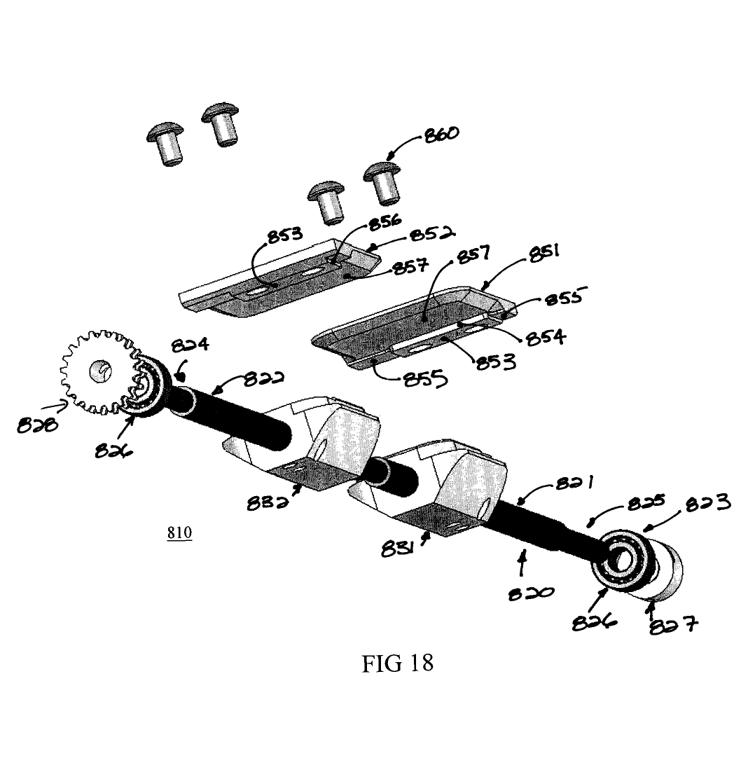

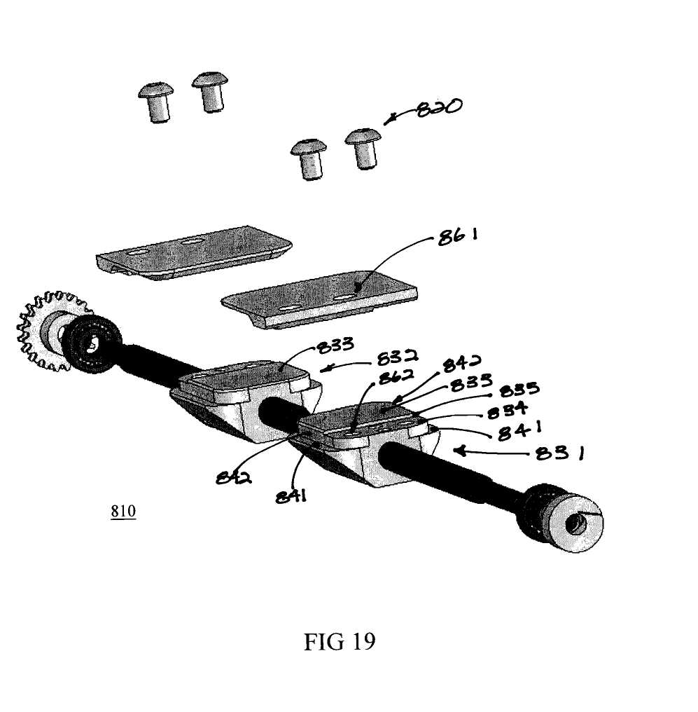

The media feed subsystem 200 includes a feed roller, a pair of pinch rollers and a feed motor and is discussed in more detail in connection with FIGS. 7 and 8. The tension control subsystem 400 includes a tension control roller that moves vertically and is discussed in more detail in connection with FIGS. 9 and 10. The home feed subsystem 500 includes a home roller with a one-way clutch, a pinch roller and a home motor and is discussed in more detail in connection with FIGS. 11 and 12. The on-the-fly cutting subsystem 600 includes a rotary cutter and is discussed in more detail in connection with FIGS. 13 and 14. The top of form subsystem is optional and includes sensors to detect an edge or a registration mark and is discussed in more detail in connection with FIGS. 15 and 16. The media guidance subsystem includes guide assemblies and is discussed in more detail in connection with FIGS. 17, 18, and 19.

FIG. 3 illustrates the arrangement of the various subsystems and the routing of the media through the subsystems. Although a roll of media is shown in FIG. 3, other types of media sources can also be used. The media is routed between the feed roller and the pinch rollers of the media feed subsystem 200. The media feed subsystem pulls the media from the roll through the first set of media guide assemblies 800a. A feed motor in the media feed subsystem controls the velocity of the feed roller based on the relative position of the media feed subsystem and the tension control subsystem. From the media feed subsystem, the media is routed under the tension control roller of the tension control subsystem 400. The tension control roller moves vertically and puts tension on the media. The tension control subsystem isolates the tension presented to the print engine from the tension used to feed the media. After passing under the tension control roller, the media is routed between the home roller and the pinch roller in the home feed subsystem. A one-way clutch attached to the home roller insures that the home roller rolls free in a single direction, i.e. towards the print engine. After passing between the home roller and the pinch roller, the media is routed between the sensors of the top of form subsystem. The sensors communicate media position information to the print engine which can be used to determine a print or cut point. From the top of form subsystem, the media is routed through the on-the-fly cutting subsystem and then into the print engine at the input feed rollers 45.

To load the media, the media is routed through the first set of media guides 800a, the media feed subsystem 200, the tension control subsystem 400, the home feed subsystem 500 and through the second set of media guides 800b. The routing can be either manual or automatic. The home feed subsystem initially feeds the media through the on-the fly cutting subsystem to the input feed rollers of the print engine until the media is properly positioned with respect to the print engine. When the print cycle is initiated, the print engine begins to pull the media into the print engine. At the point where the velocity of the media generated by the print engine exceeds the velocity of the media generated by the home feed subsystem, the home feed subsystem is deactivated so that the home motor no longer rotates the home roller. Deactivating the home feed subsystem causes the tension control roller to move in an upward direction as the length of the media between the media feed subsystem and the home feed subsystem is reduced. The upward motion of the tension control roller causes the feed roller of the media feed subsystem to rotate and to draw additional media off the roll. As the additional media is drawn off the roll, the tension control roller moves in a downward direction until it reaches a predetermined position. As the print engine pulls the media, the media feed subsystem and the tension control subsystem reach an equilibrium point with the home roller where the velocity of the media being pulled into the print engine equals the velocity of the media being pulled off the roll. At the equilibrium point, the tension control subsystem provides a constant loaded catenary tension to the media and the home feed roller is free-wheeling.

At the end of the print job, the on-the-fly cutting subsystem cuts the media, which eliminates the tension on the media entering the print engine. The one-way clutch associated with the home roller prevents the media remaining in the feeder cutter from being pulled back toward the media feed subsystem. The activation of the one-way clutch also fixes the rotation of the tension roller. The media feed subsystem feeds additional media off the roll and into the tension control subsystem causing the tension roller to move downward until it reaches a predetermined position. Once it reaches the predetermined position, the media feed subsystem stops feeding media. At this point, the feeder cutter is ready to feed media for a new print job.

Feeder Cutter Subsystems

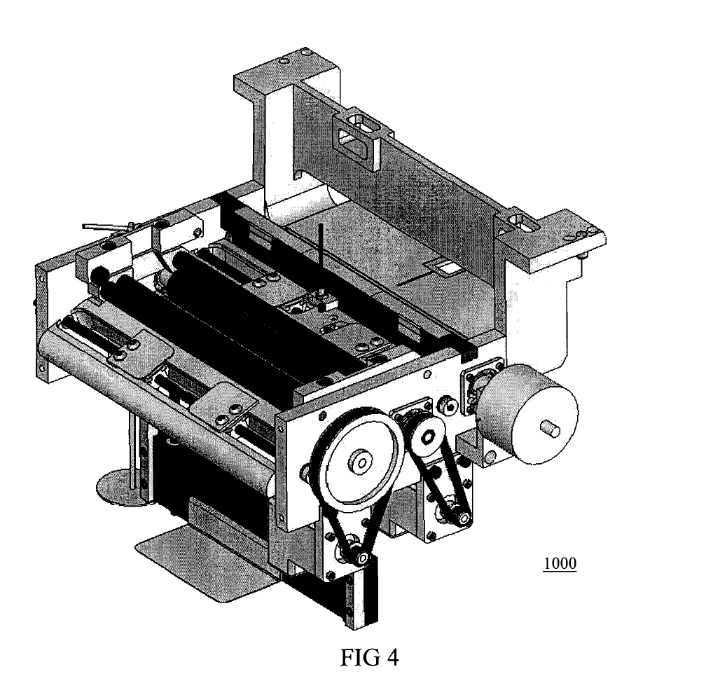

FIG. 4 illustrates the subsystems of the feeder cutter positioned in the alignment frame. The individual subsystems and components of the feeder cutter are discussed in detail in the following paragraphs. Many of the subsystems and components include pairs, such as a pair of bores or a pair of shafts. In some instances only one member of the pair is described. However, it should be understood that the description also applies to the other member of the pair.

Exemplary Alignment Frame

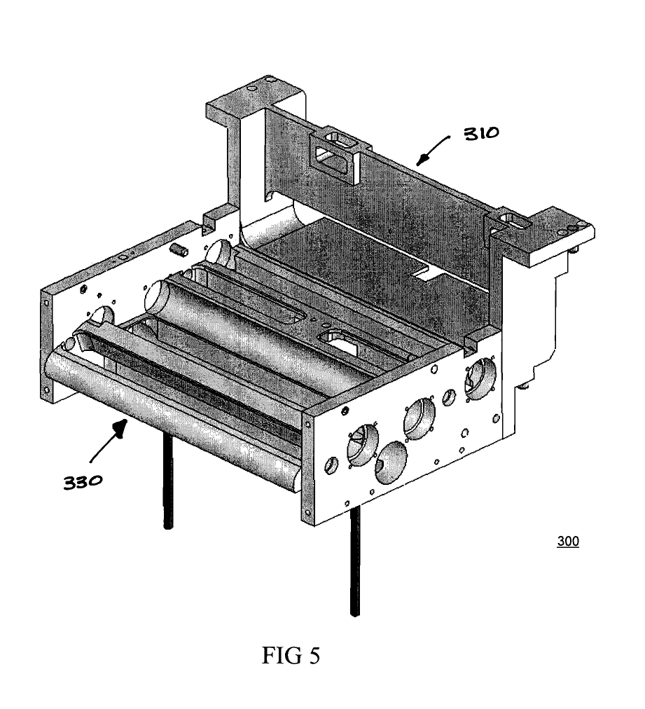

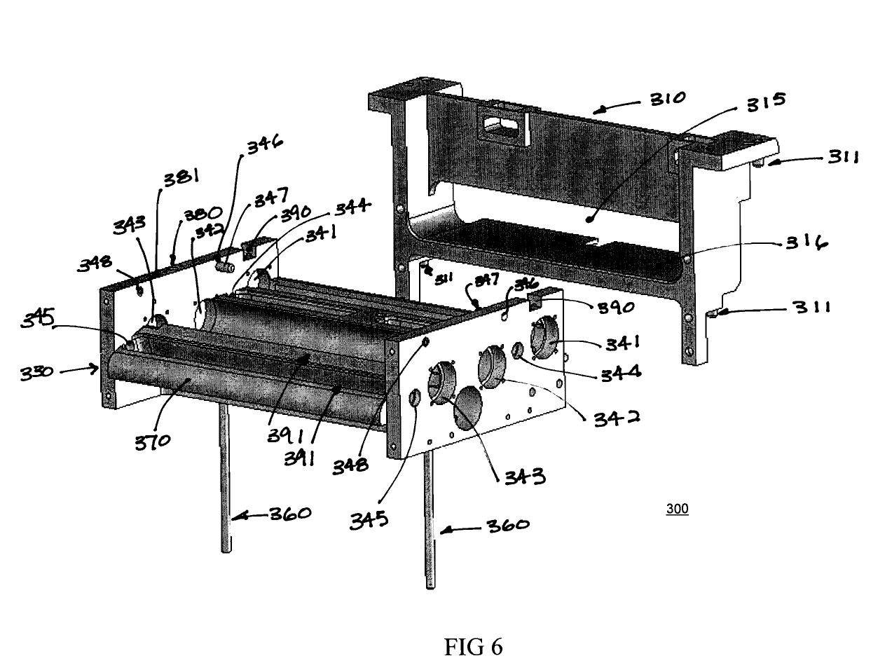

The alignment frame is illustrated by FIGS. 5 and 6. The alignment frame positions the subsystems of the feeder cutter relative to each other and relative to the media source and the print engine. In one embodiment, the alignment frame 300 is comprised of two structural aluminum machined housings, an infeed housing 330 and an interface structure 310. The housings are joined mechanically to form a single structure. The interface structure 310 has location features 311 in direct mechanical contact with the print engine. The placement of the location features is chosen so that when the alignment frame is joined to the print engine, the reference coordinate system used by the print engine can be extended to the alignment frame through the selection of geometric dimensions and tolerances. The alignment frame includes an opening 315 through which the media passes into the print engine.

The subsystems of the feeder cutter are positioned within the alignment frame. A number of coaxially paired bores provide mechanical fixed positioning of the bearing support members for the subsystems. Bores 343 position the media feed subsystem, bores 342 position the home feed subsystem, bores 341 position the on-the-fly cutting subsystem, and bores 344 and 345 position the media guidance subsystem. Bores 343, 342, and 341 are positioned along the linear media path between surface 370 and opening 315, with bores 343 closest to the surface 370, bores 341 closest to the opening 315 and bores 342 between bores 343 and 341. Bores 344 are positioned between bores 342 and 341 and bores 345 is positioned between surface 370 and bores 343. Pivot shafts 347 in bores 346 and bores 348 position the pinch rollers of the media feed and home roller subsystems. All of the bore pairs are positioned so that each pair of bore axes is collinear, each collinear axis formed by each pair is parallel to the other collinear bore pair axis, each collinear axis formed by each pair is perpendicular to the straight line path of the media, and parallel to the axes of the print engine apparatus input rollers 45.

A pair of linear bearing shafts 360 are connected into bores in the infeed housing (not shown) such that their individual axis are contained in a common plane, their individual axis are parallel, the plane formed by the linear bearing shaft pair and the print engine input roller axis are parallel, and their individual axis are parallel to a plane containing the edge of the media which is perpendicular to the surface of the media. The linear bearing shafts are part of the tension control subsystem. The linear bearing shafts are positioned between bore pairs 343 and 342. Other threaded holes and features are provided in the alignment frame for assembly of the subsystems and components. The forgoing provides the positions and geometries used in one embodiment of the invention. Other positions and geometries will be apparent to one skilled in the art.

Exemplary Media Feed Subsystem

The media feed subsystem is illustrated by FIGS. 7 and 8. The media feed subsystem 200 includes a feed roller 205 with a cylindrical outer surface 210. Shafts project from a first end of the feed roller 220 and a second end of the feed roller 230. The shafts are coaxial with the feed roller and include a reduced diameter portion. Outer race bearing retainers 236 contain bearings 235 within bores 343. The reduced diameter portion of the shaft at the first end of the feed roller 220 extends through one of the bores 343 and is connected to a first pulley 240 in the feed motor assembly 242. The reduced diameter portion of the shaft at the second end of the feed roller 230 extends through the other bore 343 and is connected to a clutch assembly 250.

Mechanical clutch assembly 250 includes a spring loaded face clutch positioned between the alignment frame and the second end of the media feed roller. The clutch provides a selectable resisting torque value to the feed roller when the feed roller is rotated. The media feed subsystem also includes a feed motor assembly 242 which provides motive force for rotating the feed roller. The feed motor assembly is a standard commercial motor and is attached to the alignment frame by fasteners 244. The feed motor assembly drives a second pulley 243, which is coupled to the first pulley by a belt 245. The rotational velocity output by the feed motor assembly is based on information received from positional sensor assembly 401. The positional sensor assembly provides information about the distance from the positional sensor assembly to the upper surface 421 of the target 402. The positional sensor assembly is attached to the alignment frame and is perpendicular to surface 421, which is attached to the tension beam of the tension control subsystem. As the distance between the positional sensor assembly and the surface increases, the feed roller velocity decreases.

A pair of pinch roller arms 265 positions the pinch rollers relative to each other and includes bores 269a and threaded bores 266. The end shafts of the pinch rollers are positioned in bores 269a, which also include bearings. A pair of pinch roller beams 271 is connected to the pinch roller arms and positions the pinch rollers within the alignment frame. Shoulder bolts 267 are installed through bores 270 in pinch roller beams 271, through springs 272 positioned between the pinch roller beams and the pinch roller arms, and into the threaded bores 266 of the pinch roller arms. A pair of shafts 347 on the alignment frame extends through bores 275 in the pinch roller beams and allows pivotal motion of the pinch roller beam. The pivotal motion is limited by plungers 280, which extend through bores 282 in the pinch roller beams and into bores 348 of the alignment frame. The shoulder bolts 267 and the springs 272 cooperate to prevent direct surface contact between the pinch roller arm and the pinch roller beam. When a pinch roller beam is pivoted to allow for coaxial engagement of the plunger end 281 into bore 348, the spring force pushes the pinch roller arm and the pinch roller beam apart and the shoulder bolts allow the pinch roller beam to move away from the pinch roller arm.

The media is fed through the media feed subsystem so that one side of the media contacts the feed roller surface 210 and the other side of the media contacts the pinch roller surfaces 261. The rotational axes of the pinch rollers 262 are parallel to one another and are a fixed distance apart. When the pinch rollers are in full line contact with the feed roller, then the vector of resultant force applied to the feed roller is through the feed roller axis of rotation.

Exemplary Tension Control Subsystem

FIGS. 9 and 10 illustrate one embodiment of the tension control subsystem. The tension control subsystem 400 includes a tension control roller 405 with a cylindrical outer surface 410 and coaxial shafts projecting from a first end of the roller 420 and a second end of the roller 430. The shafts are coupled to bearings 435, which are press mounted in mating bores of structural tension arms 440. The tension arms are mounted to the tension beam 450 such that the plane formed by parallel bore axes 460 in the tension beam is parallel to the tension roller axis of rotation, and a plane perpendicular to the bore axes 460 is parallel to the tension roller axis of rotation. The spacing of the bore axes 460 is equal to the spacing of linear bearing shafts 360 of the alignment frame, which are inserted into the bore axes. The target 402 is attached to the tension beam and facilitates the positioning of the tension control subsystem during operation. The target is discussed in more detail in connection with the media feed subsystem.

Linear bearings are coaxially fixed within the bore axes 460 of the tension beam and allow the tension control subsystem to travel along the linear bearing shafts. The geometry of the components of the tension control subsystem and the linear bearing shafts establishes a linear motion of the tension roller, which provides tension and contact across the width of the media and around a portion of the circumference of the tension roller at any cross-section of the tension roller perpendicular to the tension roller axis. If the tension control roller has a uniform cylindrical outer surface, then the tension across the width of the media is also uniform. The tension control subsystem provides equal tension in the media segments spanning the tension subsystem regardless of the media width or placement of the media width along the axial length of the tension roller. The diameter of the tension roller is selected so that the tension roller can pass between the installed feed roller and home roller to aid in the loading of media.

A limiting assembly 470 limits the travel of the tension control subsystem and facilitates loading of the media in the assembled feeder cutter. The limiting assembly includes a lift rod 471 with a pin 472 at a first end 475 and a washer 473 and nut 474 at a second threaded end 476. The lift rod is inserted in bore 380 in the alignment frame. The bore 380 is proximate to one of the linear bearing shafts and the axis of bore 380 is parallel to the axis of the linear bearing shaft. The movement of the tension control subsystem is limited in a downward direction by lower surface 480 of the tension beam contacting the washer 473 and the pin 472 contacting surface 381 of the alignment frame. In this manner, the limiting assembly prevents the tension control subsystem from traveling beyond the linear bearing shafts.

After the media is routed over the feed roller 205, the media is routed under and in contact with the tension control roller 405. The tension control subsystem uses gravity to pull the media taut against the torque resistances of the media feed subsystem and the home feed subsystem. The media follows a loaded catenary curved path through the media feed subsystem, the tension control subsystem and the home feed subsystem. The tension is equalized in the tension control subsystem due to the free rolling state of the tension control roller. The free-rolling state of the tension control roller allows the separation of the feed velocity used to feed the media from the media source from the feed velocity used to feed the media in the print engine. In addition, the free-rolling state isolates the print engine from any tension disturbances in the media at the point the media is fed from the media source. Although the foregoing describes that the tension roller moves in a vertical direction, in other embodiments the tension roller moves in other directions. In these embodiments, a constant force spring device or pressure can be used to control the movement of the tension roller.

Exemplary Home Feed Subsystem

The home feed subsystem is illustrated by FIGS. 11 and 12. In one embodiment, the home feed subsystem 500 includes a home roller 505 having a cylindrical outer surface 510 and coaxial shafts extending from a first end of the home roller 520 and a second end of the home roller 530. Outer race bearing retainers 236 contain bearings 235 within bores 342 of the alignment frame. The shaft at the first end of the home roller extends through one of the bores 342 and is connected to bore 541a of the clutch pulley assembly 540. The shaft at the second end of the home roller extends through the other bore 342 and is connected to the clutch assembly 550. The positioning of the components of the home feed subsystem in the alignment frame allows only rotation about the home roller axis.

Clutch assembly 550 is a needle roller clutch which allows the home roller to rotate in a single direction. In the illustrated embodiment, the home roller is permitted to rotate clockwise when viewed from the first end 520 of home roller 505 towards the second end 530 of the home roller.

Clutch pulley assembly 540 includes a needle roller clutch 541b coaxially connected with clutch pulley 541c. The clutch pulley assembly allows the home roller to rotate in the same single direction, i.e. clockwise for the illustrated embodiment. The home motor assembly 542 includes a second pulley 543 in contact with belt 545 and is attached to the alignment frame using fasteners 544. The home motor assembly provides planar operation of the belt, clutch pulley and second pulley. The rotational velocity output by the home motor assembly is based on information received from the print engine. For simplicity, the connections to the print engine are not shown.

The home feed subsystem also includes media guide 590. In one embodiment, the media guide is flexible and is constructed of light gage sheet metal. The media is routed between the media guide 590 and the surface 316 of the alignment frame and then into the print engine. The geometry of the media path coincides with the input roller path of the print engine. The compressive contact force and media contact area can be varied by varying the selection of spring parameters, pinch roller materials, roller diameters, and the geometry of the installed subsystem.

The media is fed through the home roller subsystem so that the home roller surface 510 contacts one side of the media and the pinch roller surface 561 contacts the other side of the media. The cylindrical pinch roller 562 is loaded on its ends so that the vector of resultant force applied to the home roller when the pinch roller is in full line contact with the home roller is through the home roller axis of rotation. The pinch roller 562 is positioned in the pinch roller arms 265 in a manner similar to that described in connection with the pinch rollers of the media feed subsystem.

Exemplary On-the-Fly Cutting Subsystem

FIGS. 13 and 14 illustrate the components of the on-the-fly cutting subsystem 600. The on-the-fly cutting subsystem cuts the media from edge to edge without interrupting the print process or changing the velocity of the media in the print engine. The media is cut while the media is under tension. If the media is not under tension when cut, then registration problems may result with some print engines. The on-the-fly cutting subsystem works with print engines where the media is moving during the print process, as well as print engines where the media is stationary during the print process. One advantage of the placement of the on-the-fly cutting subsystem is that the length of the media between the cut and the printed media is minimized. An alternative placement of the on-the-fly cutting subsystem is on the output side of the print engine.

The on-the-fly cutting subsystem includes a rotary cutter 605 having a cylindrical shape with coaxial shafts projecting from a first end of the cutter 620 and a second end of the cutter 630. The shafts extend through bores 341. Bearings 235 are contained in the bores 341 by outer race bearing retainers 236. The shaft at the first end of the cutter includes flat features on the shaft surface so that when the actuator interface 642 is in contact with the shaft at the first end of the cutter, the slot 641 faces and the faces of the flat features are coplanar. This arrangement transmits mechanical torque between the actuator interface and the rotary cutter. The shaft at the second end of the cutter extends through bore 652 in spring return block 651 of spring return assembly 650. The positioning of the components of the on-the-fly cutting subsystem allows the cutter to rotate along the rotary cutter axis. The rotary cutter includes a rotary cutter edge 606 which extends outward from the general cylindrical shape of the rotary cutter. The rotary cutter edge cuts the full width of the media and can cut over the full length of the rotary cutter between bearings 235.

Spring return assembly 650 assists in returning the cutter to a start-of-cut position after cutting the media. A cutter return spring mount block 653 includes a slot 654 corresponding to the thickness of cutter return spring 655 which fits into the slot, and mounting holes 656. Fasteners 657 extend through mounting holes 656 to attach the cutter return spring mount block to the alignment frame. Spring return block 651 includes a threaded bore 658a which is perpendicular to bore 652 and intersects bore 652. A fastener 658b attaches the spring return block 651 to the shaft at the second end of the cutter so that surface 658c is in contact with cutter return spring 655. The spring return assembly helps restore the rotary cutter to its original position after a cut is made.

Rotary actuator assembly 640 includes an electromechanical rotary actuator 643, an actuator interface 642 attached to the actuator output shaft, an actuator structural bracket 644, and fasteners for mounting the rotary actuator to the bracket. The output motion of the rotary actuator is a coaxial rotation about an axis containing the rotary actuator shaft and collinear with the rotary cutter axis of rotation. Fasteners 645 extend through the bracket and attach the rotary actuator assembly to the alignment frame.

The rotation angle of the rotary actuator and hence the rotation angle of the rotary cutter is generally set by the manufacturer of the rotary actuator and in one embodiment is 45 degrees clockwise when viewed from the first end of the rotary cutter looking along the rotary cutter axis towards the second end. The initial position of the rotary cutter is determined by the orientation of the components such that the rotary cutter edge 606 cuts from the first side of the media through to the second side, where the first side of the media is in contact with surface 510 of the home roller and surface 316 of the alignment frame. A stationary blade assembly 670 with a sharp straight cutting edge 671 is positioned parallel to the rotary cutter axis of rotation and at the radial distance from the rotary cutter axis of rotation matching the rotary cutter edge distance. The edge 671 is manufactured on a hardened steel plate and fasteners 673 are inserted in tapped holes in stationary blade beam 674. The dimensions and geometry of the first end 676 of the stationary blade, the second end 675 of the stationary blade and the slots 390 in the alignment frame position the edge 671 to be coincident with the rotary cutter edge.

The inherent positioning gaps that result when the stationary blade assembly is positioned coincidentally to the rotary blade cutting line of action are filled with shim material 677. Fasteners 679 are inserted through bores 678 to connect the stationary blade assembly to the alignment frame. The rotary cutter is rotated by the rotary actuator assembly based on information from the print engine. Once the rotary actuator is deactivated, the spring return assembly rotates the rotary cutter back to its original position.

Exemplary Top of Form Subsystem

An exemplary top of form subsystem 700 is illustrated by FIGS. 15 and 16. The top of form subsystem detects media edges or pre-printed patterns on the media and communicates the information to the print engine. The top of form subsystem includes a first optical sensor emitter system assembly 710 and a second optical sensor receiver system assembly 730 which form a transmissive sensor pair. The first optical sensor emitter system assembly 710 is attached to an optical sensor block 720, which is in turn attached to the alignment frame. The first optical sensor emitter system is perpendicular to the media and spaced above the media. The second optical sensor receiver system assembly 730 is attached to the alignment frame at a through threaded hole collinearly positioned with the emitter assembly 710. The second optical sensor receiver system assembly detects the signal originating from the emitter. The top of form subsystem also includes a third coaxial optical sensor 740 that includes both an emitter and a receiver. The third coaxial optical sensor is attached to the alignment frame at a through threaded hole and is positioned perpendicular to the media and at a specified distance from the media. The optical sensor assemblies communicate with the print engine through optical cabling and interface electronics (not shown).

Exemplary Media Guidance Subsystem

FIGS. 17, 18 and 19 illustrate an exemplary media guidance subsystem 800a, 800b, referred to herein collectively as 800. The media guidance subsystem positions and aligns the moving media through the feeder cutter and presents the media to the print engine. The media guidance subsystem includes two guide assemblies 810. The first guide assembly is positioned in the alignment frame via bores 345 and the second guide assembly is positioned in the alignment frame using bores 344. The guide assemblies include a guide screw 820 with uniform cylindrical threaded outer surfaces 821, 822, a shaft at the first end of the guide screw 823, and a shaft at the second end of the guide screw 824. The shafts extend coaxially from the threaded outer surfaces. The shaft at the first end of the guide screw 823 extends through bearings 826 and into bearing retainer 827 and the shaft at the second end of the guide screw 824 extends through bearings 826 and into sprocket 828. The bearings 826 are installed in bores 345 and 344 of the alignment frame and the bearing retainers 827 and the sprocket 828 fix motion along the guide screw axis and allow only rotation about the guide screw axis.

Guide blocks 831 and 832 are screwed onto the guide screw. The guide blocks include flat surfaces 833 and 834 which are parallel to each other and surfaces 835 which are perpendicular to surfaces 833 and 834. Surface 841 is parallel to surface 833 and in one embodiment is approximately 0.125″ below surface 833 and extends approximately 0.125″ perpendicular to surface 842. Guide caps 851 and 852 include surfaces 853 and 857 which are parallel to each other and surface 854 which is perpendicular to surfaces 853 and 857. Surfaces 855 are parallel to surfaces 857 and in one embodiment extend approximately 0.020″ above surfaces 857 and approximately 0.125″ perpendicular to surfaces 856. In one embodiment, the resultant surfaces 856 are parallel to each other on each cap, and at a separation distance of 0.875″.

The guide caps 851 and 852 are attached to the guide blocks 831 and 832 using fasteners 860 inserted through bores 861 and into threaded holes 862. Once the guide caps are attached to the guide blocks, surfaces 853 contact surfaces 834, surfaces 854 contact surfaces 835 and there is a gap between surfaces 857 and 853. The media is routed through the gap and the exposed portions of surfaces 854 guide the edges of the media. The distance between the surfaces 854 of the guide caps is adjusted by rotating the guide screws to accommodate different media widths. There is also a gap between surfaces 855 and 841 which capture boss features 391 in the alignment frame. The boss features 391 are parallel to each other, to the bore axis of bore pair 345, and in one embodiment are separated by 0.880″. This arrangement provides a guided rail system that allows only a single degree of freedom of linear travel of the guide blocks perpendicular to the media path.

The four guide blocks and caps limit the media motion to travel along the media path. To provide for rapid adjustment of the guide assemblies to accommodate different media widths, a toothed belt 870 is connected to the sprockets 828 of the guide assemblies. Additional sprockets rotating on axles 871 positioned in the alignment frame remove any slack in the belt and allow for simultaneous and equal rotation of the guide screws and hence simultaneous and equal travel of the guide blocks and caps. A thumbwheel 872 is attached to the second end of one of the guide assemblies to facilitate manual rotation of the guide screws.

Additional alternative embodiments will be apparent to those skilled in the art to which the present invention pertains without departing from its spirit and scope. For example, instead of using a roller clutch in the home feed subsystem and a tension roller as described above, a drag clutch and a sensor can be used instead. The sensor is used to control the velocity of the media drawn from the media source. Another alternative includes a motorized media roll, which eliminates the media feed subsystem and the tension roller. Again a sensor is used to control the velocity of the media drawn from the media source.

Although the invention has been described in the context of a feeder cutter adapted for a sheet feed printer, the invention includes the feeding of any type of material stored on a spool. In addition, the components and positions of the components described above can be modified to accommodate different printer requirements or can be modified to accommodate a cutter feeder integrated into a dedicated print system. Accordingly, the scope of the present invention is described by the appended claims and is supported by the foregoing description.

What is claimed is:

1. A feeder for feeding continuous media from a media source, comprising:
a media feed subsystem operable for drawing the continuous media from the media source at a media feed velocity;
a tension control subsystem positioned between the media feed system and a home feed system for maintaining tension on the continuous media in the feeder between the media feed subsystem and the home feed subsystem; and
the home feed subsystem for selectively feeding the continuous media to a print engine and for controlling movement of the continuous media to only allow movement of the continuous media in a first direction.

2. The feeder of claim 1, wherein the media feed subsystem includes a media feed roller, at least one media feed pinch roller, and a feed motor, wherein the feed motor rotates the media feed roller in the first direction so that the continuous media is drawn from the media source and the continuous media passes between the media feed roller and the media feed pinch roller.

3. The feeder of claim 1, wherein the tension control subsystem includes a tension control roller moveable relative to the media feed roller and a home roller of the home feed subsystem, wherein the tension control roller is positioned so that the continuous media follows a loaded catenary curved path through the tension control subsystem and the tension control subsystem is positioned between the media feed subsystem and the home feed subsystem.

4. The feeder of claim 1, wherein the home feed system includes a home feed roller, at least one home pinch roller, a clutch and a home motor, wherein the home motor selectively rotates the home feed roller in the first direction, the continuous media is fed between the home roller and the home pinch roller, and the clutch allows rotation of the home feed roller only in the first direction.

5. A feeder for feeding continuous media from a media source, comprising:
a media feed subsystem having a media feed roller, at least one media feed pinch roller, and a feed motor, wherein the feed motor rotates the media feed roller in a first direction so that the continuous media is drawn from the media source and the continuous media passes between the media feed roller and the media feed pinch roller so that a first side of the continuous media contacts the media feed roller and a second opposite side of the media contacts the media feed pinch roller;
a tension control subsystem having a tension control roller moveable relative to the media feed roller and a home roller of a home feed subsystem, wherein the second side of the continuous media contacts the tension control roller and the tension control subsystem is positioned between the media feed subsystem and the home feed subsystem; and
the home feed system having a home feed roller, at least one home pinch roller, a clutch and a home motor, wherein the home motor selectively rotates the home feed roller in the first direction, the first side of the continuous media contacts the home roller and the second opposite side of the continuous media contacts the home pinch roller, and the clutch allows rotation of the home feed roller only in the first direction.

6. The feeder of claim 5, wherein the tension control roller is moveable in a vertical direction, further comprising a sensor to determine a vertical distance associated with a position of the tension control roller relative to the media feed roller, wherein the media feed subsystem uses the vertical distance to control a velocity of the feed motor.

7. The feeder of claim 6, wherein the velocity of the feed motor decreases as the vertical distance increases.

8. The feeder of claim 5, further comprising:
a cutter subsystem having a rotary cutter, an acutator and a spring return assembly, wherein the cutter subsystem cuts the media under tension.

9. A method for feeding continuous media from a media source, the method comprising:
feeding the continuous media from the media source;
feeding the continuous media into a print engine at a home feed media velocity;
in response to determining that a print engine media velocity exceeds a predetermined home feed media velocity, deactivating the feeding of the continuous media at the home feed media velocity; and
maintaining tension on the continuous media presented to the print engine.

10. The method of claim 9, further comprising:
cutting the continuous feed media under tension; and
maintaining a position of the continuous media at a point between the media source and the cut.

11. The method of claim 10, wherein maintaining a position of the continuous media comprises:
controlling movement of the continuous media to allow only movement towards the print engine; and
adjusting a velocity of the media fed from the media source.

12. The method of claim 9, wherein maintaining tension on the continuous media comprises:
adjusting a velocity of the media fed from the media source.

13. A method for feeding continuous media from a media source, the method comprising:
feeding the continuous media from the media source at an initial media feed velocity;
feeding the continuous media to a print engine input at an initial home feed media velocity;
in response to determining that a print engine media velocity exceeds a predetermined home feed media velocity, allowing the continuous media to be drawn at the print engine media velocity and drawing the continuous media from the media source at an equilibrium media feed velocity; and
maintaining tension on the continuous media presented to the print engine regardless of the media feed velocity, the home feed media velocity or the print engine media velocity.

14. The method of claim 13, further comprising:
cutting the continuous media under tension;
controlling movement of the continuous media to allow only movement towards the print engine; and
adjusting the media feed velocity.

15. The method of claim 13, wherein feeding the continuous media from the media source at an initial media feed velocity comprises controlling a media feed motor.

16. The method of claim 13, wherein allowing the continuous media to be drawn at the print engine media velocity comprises deactivating a home feed motor.

17. The method of claim 13, wherein drawing the continuous media from the media source at an equilibrium media feed velocity comprises controlling a media feed motor.

18. The method of claim 13, wherein maintaining tension on the continuous media presented to the print engine comprises adjusting a position of a tension control roller.
